(19) United States
(12) Patent Application Publication
(10) Pub. No.: US 2021/0081117 A1
(43) Pub. Date: Mar. 18, 2021

(54) NON-VOLATILE MEMORY PROTECTIONS

(71) Applicant: Hewlett-Packard Development Company, L.P., Spring, TX (US)

(72) Inventors: Wei Ze Liu, Spring, TX (US); Christopher H. Stewart, Spring, TX (US); Rosilet Retonamoni Braduke, Spring, TX (US)

(73) Assignee: Hewlett-Packard Development Company, L.P., Spring, TX (US)

(21) Appl. No.: 16/980,890

(22) PCT Filed: Jun. 7, 2018
(86) PCT No.: PCT/US2018/036455

§ 371 Date: Sep. 15, 2020

(51) Int. Cl. G06F 3/06; G06F 21/78

(52) U.S. Cl. CPC G06F 3/0622; G06F 21/78; G06F 3/0676; G06F 3/0655

(57) ABSTRACT

In example implementations, an apparatus is provided. The apparatus includes a controller, a memory protection policy, an electrically isolated memory, and a non-volatile memory. The memory protection policy includes an allowable write function. The electrically isolated memory is to store code executable by the controller to execute a requested write function based on the set of memory protections. The non-volatile memory is in communication with the controller. The requested write function is to be executed in the non-volatile memory when the requested write function matches the allowable write function.

### BACKGROUND

Computers are electronic devices that have hardware components that are programmed to execute software instructions. Computers may operate based on an operating system. Different operating systems exist that have different characteristics, advantages, disadvantages, and the like. The operating systems provide an interface to allow users to interact with software applications on the computers and provide rules for how the hardware components may execute the software instructions.

The computers may also include start-up software that provides an interface between the operating system and firmware of the computer and/or associated peripherals of the computer. The start-up software may be executed upon powering on the computer and may perform tasks to prepare the computer and the associated peripherals of the computer for operation.

### BRIEF DESCRIPTION OF THE DRAWINGS

FIG. 1 is a block diagram of an example computing system having a firmware with non-volatile memory protections of the present disclosure;

FIG. 2 is a block diagram of an example apparatus of the firmware with non-volatile memory protections of the present disclosure;

FIG. 3 is a block diagram of an example non-transitory computer readable storage medium storing instructions executed by a processor to protect non-volatile memory of the present disclosure; and

FIG. 4 is a block diagram of an example non-transitory computer readable storage medium storing instructions executed by a processor to protect write execution of unified extensible firmware interface (UEFI) variables in non-volatile memory of the present disclosure.

### DETAILED DESCRIPTION

Examples described herein provide protections for non-volatile random access memory (NVRAM) in computing systems. As discussed above, computers may include start-up software that provides an interface between the operating system and firmware. One example of the start-up software may include a unified extensible firmware interface (UEFI). UEFI has been deployed recently to improve the basic input/output system (BIOS) software in computers.

UEFI can provide many advantages over current BIOS software. For example UEFI can provide the ability to use large hard disk drives, can provide a modular design, can provide backward and forward processor compatibility, can provide a variety of different services, can allow for execution of UEFI applications, and the like.

UEFI may support operation of the operating system by executing certain functions. For example, the UEFI may read and write UEFI variables to a non-volatile random access memory (NVRAM). The NVRAM may have a limited amount of memory space (e.g., 512 kilobytes (KB) or little as 256 KB. When the UEFI comes under a denial of service (DOS) attack, the DOS attack may quickly fill up the NVRAM with common variables and prevent the UEFI from writing UEFI variables that the operating system uses to execute properly.

Examples herein tag or label the UEFI variables that can be written to the NVRAM. When pre-defined usage thresholds of the NVRAM are exceeded, a rules policy may be implemented that controls which UEFI variables can be written to the NVRAM. The tag or label of the UEFI variable may be compared to the rules policy to determine whether the UEFI variable may be written to the NVRAM. Thus, unlike previous protections that try to prevent access to the UEFI, the present disclosure provides protections that are implemented and controlled by the UEFI.

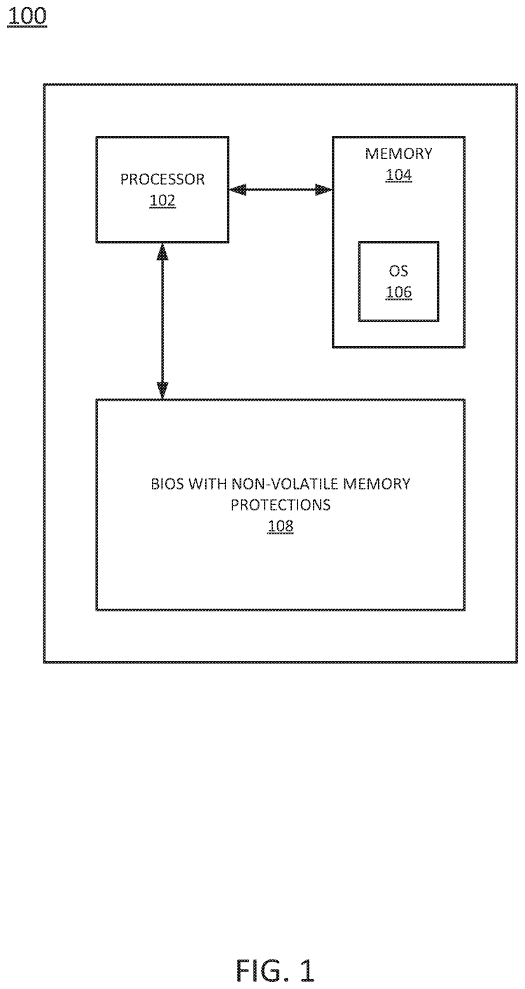

FIG. 1 illustrates a block diagram of an example computing system 100 of the present disclosure that includes a firmware with non-volatile memory protections 108. Firmware may include instructions that provide control for device specific hardware. The firmware may be executed when hardware is powered on and before control is handed over to the operating system of the hardware. Examples of firmware may include the basic input/output system (BIOS) or the unified extensible firmware interface (UEFI).

In one example, the computing system 100 may include a processor 102, a memory 104, and the firmware with non-volatile memory protections 108. The processor 102 may be communicatively coupled to the memory 104 and the firmware with non-volatile memory protections 108. The processor 102 may execute instructions stored on the memory 104.

In one example, the memory 104 may be a non-transitory computer readable medium, such as, a hard disk drive, a random access memory (RAM), and the like. The memory 104 may store an operating system (OS) 106. The processor 102 may execute the OS 106.

At boot time, the OS 106 may attempt to get information stored in the BIOS with non-volatile memory protections 108. In one example, the OS 106 may execute an application programming interface (API) to get/set firmware variables. The API may interact with the BIOS with non-volatile memory protections 108.

In one example, the firmware with non-volatile memory protections 108 may be a BIOS or a UEFI. The UEFI may allow the API to get variables (e.g., read) or set variables (e.g., write). The UEFI may use different variables to set values for different system functions executed by the OS 106.

The variables may be identified by a globally unique identifier (GUID). The GUID may be a generated number or value that is used to identify a variable. Each variable may be associated with a unique GUID. The variables may be categorized based on the GUID. For example, variables may have different levels of importance or security. The variables may be categorized based on these different levels of importance or security using the associated GUID. The firmware with non-volatile memory protections 108 may control which variables can be written in the UEFI based on the categorized variables, as discussed in further details below.

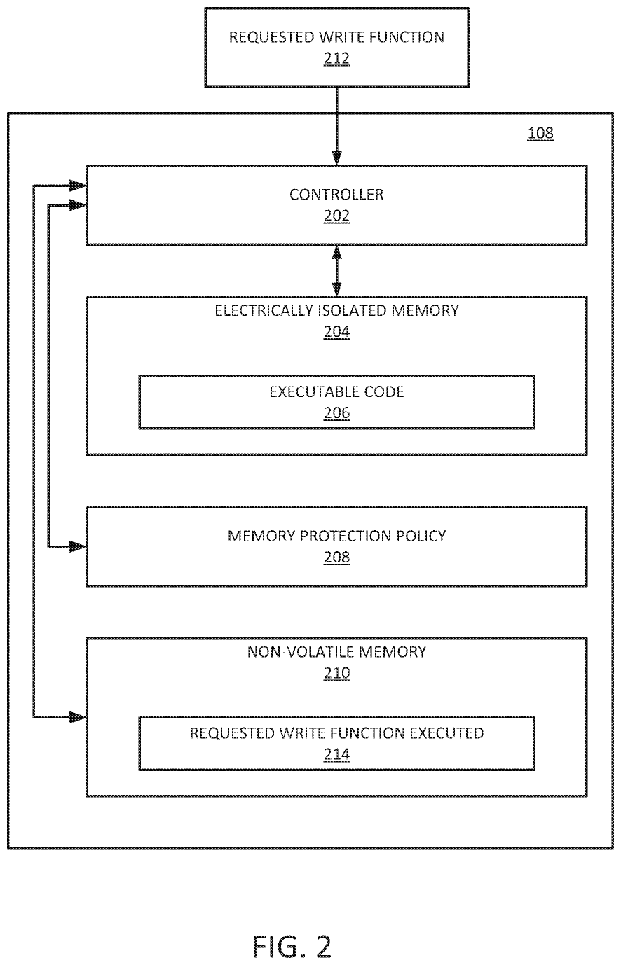

FIG. 2 illustrates an example of an apparatus 108 of the firmware with non-volatile memory protections (also referred to herein as the apparatus 108). The apparatus 108 may include a controller 202, an electrically isolated memory (EIM) 204, a memory protection policy 208, and a non-volatile memory 210. The controller 202 may be communicatively coupled to the EIM 204, the memory protection policy 208, and the non-volatile memory 210.

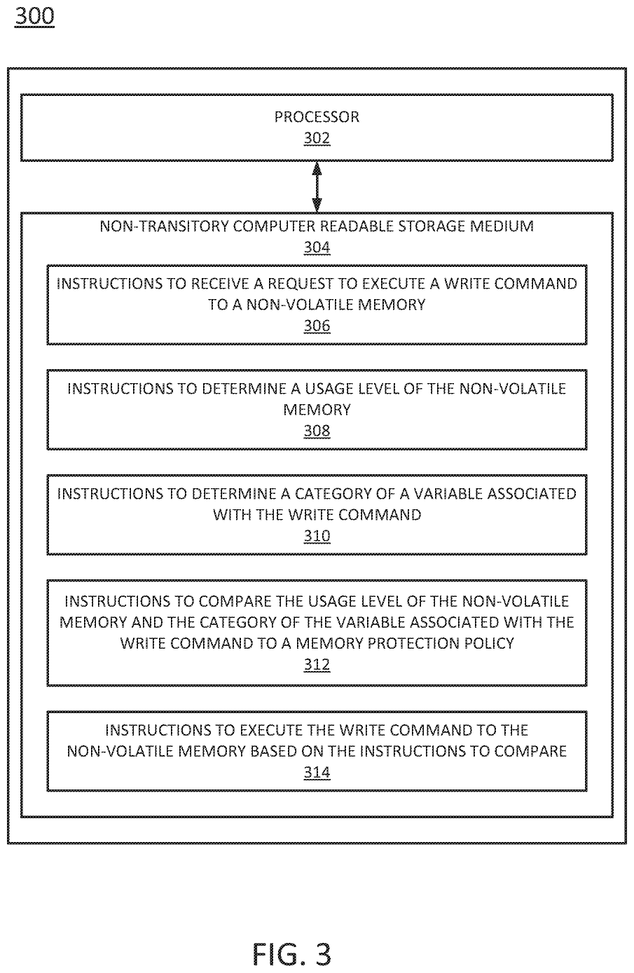

In one example, the EIM 204 may be a secure memory space in the apparatus 108. For example, the EIM 204 may be a serial performance interface (SPI) chip. The SPI chip may be an electrically isolated memory chip located on the SPI of the BIOS or UEFI. The EIM 204 may store executable code 206. The executable code 206 may be code to execute a requested write function 212 based on the memory protection policy 208. In other words, the executable code 206 may provide the non-volatile memory protection in the BIOS of the computing system 100. The executable code 206 may include the functions described below or the instructions illustrated in FIG. 3, and discussed in further detail below.

In one example, the memory protection policy 208 may be rules that define whether the requested write function 212 may be executed in the non-volatile memory 210. The non-volatile memory 210 may be a non-volatile random access memory (NVRAM). The size of the non-volatile memory 210 may be limited. For example, the amount of memory space in the non-volatile memory 210 may be 128 kilobytes (kb) to 528 kb. Thus, the non-volatile memory 210 may be susceptible to a denial of service (DoS) attack, as noted above.

The DoS attack may cause the API of the OS of a computing system to continuously send SetVariable commands to a UEFI. The SetVariable command in UEFI may be used to write variables into the non-volatile memory. During the DoS attack, the SetVariable command can be used to cause junk variables, or unimportant variables, to be continuously written into the non-volatile memory. Filling the non-volatile memory with the junk variables may prevent other important variables from being properly written to the non-volatile memory. As a result, the OS may fail to boot. The executable code 206 executed with the memory protection policy 208 may prevent such DoS attacks to the firmware with non-volatile memory protections 108.

In one example, the memory protection policy 208 may be categories of variables for the UEFI of the apparatus 108. The categories of variables may create a tiered policy. In one example, the categories may include 1) digitally signed variables, 2) other security-critical variables that are not digitally signed, 3) other variables that are known, and 4) and unknown variables. Digitally signed variables may be UEFI authenticated variables or other variables that contain digitally signed data that the firmware can verify before writing. The other security-critical variables may be variables that store an enabled or disabled state of the UEFI Secure Boot. The other variables that are known may be UEFI variables that do not directly impact the security of the computing system 100. In one example, variables that are in category 1) and 2) may be written to the non-volatile memory 210 and variables that are in category 3) and 4) may not be written (or any other pre-defined allocation of permissions).

For example, the controller 202 may receive the requested write function 212 (e.g., a SetVariable command). The variable associated with the requested write function 212 may be identified based on a GUID. The GUID may be searched for in the memory protection policy. When a match is found, the variable may be identified based on the GUID and the category that the variable falls under may be determined based on the memory protection policy 208. The variable may be an unknown variable under category 4). As a result, the requested write function 212 may be denied. Although an example with four tiers is illustrated above, it should be noted that the memory protection policy 208 may include any number of tiers or different categories.

In one example, each one of the categories may be tiered based on a remaining available non-volatile memory space. For example, each category may be associated with a different threshold based on a remaining available non-volatile memory space. The thresholds may be incrementally lower as the importance of each variable increases. In one example, the threshold may be a respective non-volatile memory usage threshold. The threshold may be a percentage or a real value. For example, using the example four categories above, the digitally signed variables may have a threshold of 99% or 522 kb for a 528 kb non-volatile memory 210. In other words, if the variable associated with the requested write function 212 is a digitally signed variable, the variable may be written to the non-volatile memory 210 as long as the memory usage of the non-volatile memory 210 does not exceed 99% or 522 kb. If the memory usage threshold is exceeded, a memory usage error may be returned to the OS 106 in response to the requested write function 212. If the memory usage threshold is not exceeded, the variable may be written to the non-volatile memory 210 (e.g., shown as a requested write function executed 214 stored in the non-volatile memory 210).

Similarly, the other security-critical variables that are not digitally signed may have a threshold of 90%, the other variables that are known may have a threshold of 75% and the unknown variables may have a threshold of 50%. However, it should be noted that the threshold associated with each category may have any value or percentage. The thresholds associated with each category may be unevenly incremented (similar to the example above) or evenly incremented (e.g., 90%, 80%, 70%, and 60%, respectively). Thus, the variables may be tiered based on a remaining available non-volatile memory space.

In one example, the threshold may be associated with a size of the variable in the requested write function 212. For example, any category of variable with a memory size greater than 100 kb may be rejected. In one example, each category may be associated with a different acceptable memory size. For example, any memory size may be acceptable for digitally signed variables, the threshold for other security-critical variables that are not digitally signed may be 100 kb, the threshold for other variables that are known may be 50 kb and the threshold for unknown variables may be 10 kb.

In one example, both thresholds may be used with each category. For example, each category may have a memory usage level threshold and data size threshold. For example, using the example values above, for other security-critical variables that are not digitally signed, if the usage level of the non-volatile memory 210 is less than 75% and the data size is less than 100 kb, the variable may be written into the non-volatile memory 210.

Thus, the memory protection policy 208 may “pre-reserve” enough space for critical/important variables to be written to the non-volatile memory 210 to allow the OS 106 to boot. Said another way, the memory protection policy 208 may prevent a DoS attack from filling the non-volatile memory 210 with junk variables (e.g., unknown variables or known variables that do not directly impact the security of the computing system 100). As the usage of the non-volatile memory 210 rises, the controller 202 may execute the executable code 206 in accordance with the memory protection policy 208 to prevent the DoS attack.

Notably, the memory protection provided by the executable code 206 and the memory protection policy 208 are executed within the firmware with non-volatile memory protections 108. The memory protection is not executed by the processor 102 of the overall computing system 100. In addition, the executable code 206 and memory protection policy 208 are not stored in the memory 104 of the computing system 100 (e.g., the hard disk drive) that can be easily hacked. Rather, the executable code 206 and the memory protection policy may be stored in the less accessible EIM 204 that provides greater security.

The memory protection policy 208 may be stored in the firmware with non-volatile memory protections 108. In one example, the memory protection policy 208 may be stored in the non-volatile memory 210. In one example, the memory protection policy 208 may be stored in the EIM 204. In one example, the memory protection policy 208 may be stored in a system management random access memory (SM RAM) (not shown) of the firmware with non-volatile memory protections 108.

In one example, the executable code 206 may be encrypted with a digitally secure signature. The digitally secure signature may be applied to the executable code 206 during manufacturing of the computing system 100. Thus, the controller 202 may know that the executable code 206 in the EIM 204 is trustworthy to execute based on the digitally secure signature.

In one example, the executable code 206 may be turned on and off. For example, a user may configure the firmware with the non-volatile memory protections 108 to have the controller 202 execute the executable code 206 using the memory protection policy 208, or to not execute the executable code 206.

FIG. 3 illustrates an example of an apparatus 300. In one example, the apparatus 300 may be the computing system 100 or the firmware with non-volatile memory protections system 108. In one example, the apparatus 300 may include a processor 302 and a non-transitory computer readable storage medium 304. The non-transitory computer readable storage medium 304 may include instructions 306, 308, 310, 312, and 314 that, when executed by the processor 302, cause the processor 302 to perform various functions described herein.

In one example, the instructions 306 may include instructions to receive a request to execute a write command to a non-volatile memory. For example, the request may be sent from a Get/Set Firmware Variable API executed by an OS of a computing system. The request may be to write a variable in non-volatile memory of a UEFI that uses UEFI variables. In one example, the request to execute the write command may be a SetVariable function of the UEFI to write the UEFI variable.

The instructions 308 may include instructions to determine a usage level of the non-volatile memory. For example, an amount of memory space used of the non-volatile memory may be determined. The amount may be represented as a real value or a percentage depending on how the thresholds are represented in the memory protection policy, as discussed below.

The instructions 310 may include instructions to determine a category of a variable associated with the write command. In one example, the request to execute the write command may be a SetVariable function for the UEFI. The request may include a GUID. The GUID may be used to find the variable associated with the GUID and which category is associated with the variable.

The instructions 312 may include instructions to compare the usage level of the non-volatile memory and the category of the variable associated with the write command to a memory protection policy. As discussed, above, the categories and the respective threshold values associated with each category may be stored in a memory protection policy. The variable identified based on the GUID may be then used to find a matching variable in the memory protection policy. The category associated with the matching variable in the memory protection policy may identify the category associated with the variable in the request to execute the write command. In addition, the usage level of the non-volatile memory may be compared to the respective threshold of the category.

The instructions 314 may include instructions to execute the write command to the non-volatile memory based on the instructions to compare. In one example, if the usage level of the non-volatile memory is below the respective threshold, the write command that was requested may be executed in the non-volatile memory. For example, the variable in the SetVariable function may be written to the NVRAM.

In one example, if the usage level of the non-volatile memory is above the respective threshold, the write command that was requested may not be executed. For example, an error message indicating that the memory usage is too high may be returned to the API of the OS.

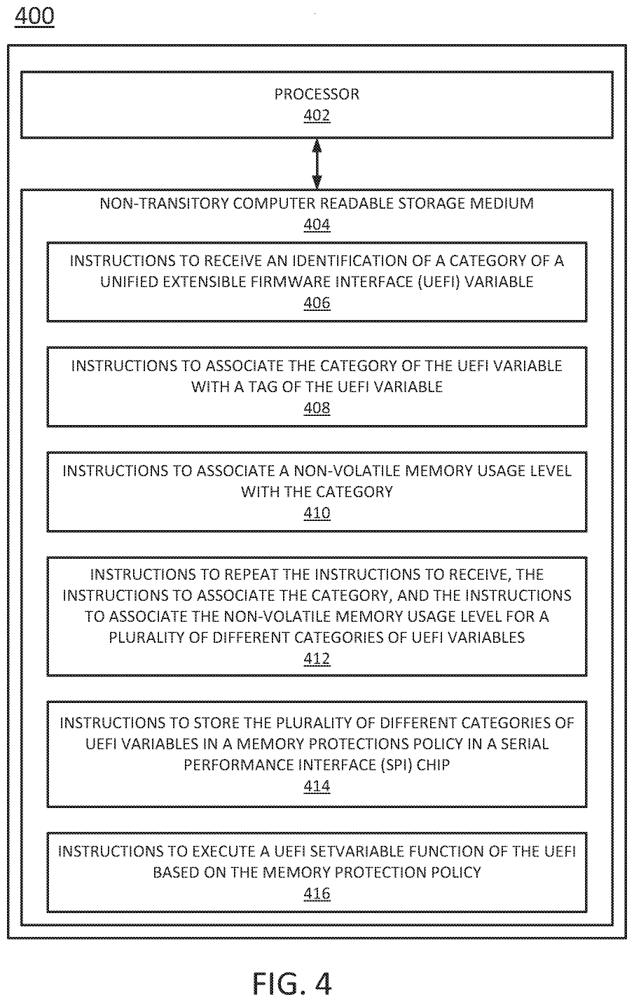

FIG. 4 illustrates an example of an apparatus 400. In one example, the apparatus 400 may be the computing system 100 or the firmware with non-volatile memory protections system 108. In one example, the apparatus 400 may include a processor 402 and a non-transitory computer readable storage medium 404. The non-transitory computer readable storage medium 404 may include instructions 406, 408, 410, 412, 414, and 416 that, when executed by the processor 402, cause the processor 402 to perform various functions described herein.

In one example, the instructions 406 may include instructions to receive an identification of a category of a unified extensible firmware interface (UEFI) variable. For example, a user interface (e.g., a display with a graphical user interface, input devices (e.g., a keyboard and mouse, a touchscreen, and the like) can be used to provide the identification of a category of the UEFI variable.

As discussed above, the UEFI may use different types of variables. The variables may store values that are used by the OS at boot time to boot the computing system. The variables may be grouped into different categories, as desired. Examples of the categories are provided above, such as, 1) digitally signed variables, 2) other security-critical variables that are not digitally signed, 3) other variables that are known, and 4) and unknown variables.

The instructions 408 may include instructions to associate the category of the UEFI variable with a tag of the UEFI variable. In one example, the tag may be GUID of the UEFI variable. The GUID of the UEFI variable may be used to determine the category associated with the UEFI variable.

The instructions 410 may include instructions to associate a non-volatile memory usage level with the category. In one example, each one of the categories may be associated with a threshold. The threshold may be an acceptable non-volatile memory usage level. More important variables may have a higher threshold value. Less important variables may have a lower threshold value. The respective threshold values may determine whether the variable can be written into the non-volatile memory.

The instructions 412 may include instructions to repeat the instructions to receive, the instructions to associate the category, and the instructions to associate the non-volatile memory usage level for a plurality of different categories of UEFI variables. For example, instructions 406, 408, and 410 may be repeated until a desired number of categories with respective thresholds of non-volatile memory usage are identified.

The instructions 414 may include instructions to store the plurality of different categories of UEFI variables in a memory protection policy in a serial performance interface (SPI) chip. In one example, the plurality of different categories of UEFI variables and the respective thresholds may be stored as part of the memory protection policy. The memory protection policy can be used to determine whether a requested write function can be executed in the non-volatile memory. The SPI may be a protected part of a memory in the BIOS or UEFI. For example, the SPI may be an electrically isolated memory in the BIOS or UEFI that can provide a secure location for the memory protection policy.

The instructions 416 may include instructions to execute a UEFI SetVariable function of the UEFI based on the set of memory protections. For example, after the memory protection policy is stored, the OS may send a SetVariable function request to the UEFI. The GUID of the variable in the SetVariable function may be identified and used to determine the category of the variable in the SetVariable function request. The non-volatile memory usage level may be determined. Based on the category of the variable matching a category in the memory protection policy and the non-volatile memory usage level being below the respective threshold, the SetVariable function may be executed in the non-volatile memory.

Thus, the memory protection policy may prevent DoS attacks on the non-volatile memory of the UEFI or BIOS. The memory protection policy of the present disclosure may ensure that important variables (variables that determine whether the OS can boot in the computing system) can be written to the non-volatile memory.

It will be appreciated that variants of the above-disclosed and other features and functions, or alternatives thereof, may be combined into many other different systems or applications. Various presently unforeseen or unanticipated alternatives, modifications, variations, or improvements therein may be subsequently made by those skilled in the art which are also intended to be encompassed by the following claims.

1. An apparatus, comprising:
a controller;
a memory protection policy indicating an allowable write function;
an electrically isolated memory to store code executable by the controller to execute a requested write function based on the memory protection policy; and
a non-volatile memory in communication with the controller, wherein the requested write function is to be executed in the non-volatile memory when the requested write function matches the allowable write function.

2. The apparatus of claim 1, wherein the write function comprises a SetVariable function of a unified extensible firmware interface (UEFI) to write a UEFI variable.

3. The apparatus of claim 2, wherein the memory protection policy comprises a plurality of different categories of UEFI variables and a respective threshold for each one of the plurality of different categories.

4. The apparatus of claim 3, where the classification of the UEFI variable is based on a globally unique identifier of the UEFI variable.

5. The apparatus of claim 1, wherein the electrically isolated memory comprises a serial performance interface chip to store the set of memory protections.

6. The apparatus of claim 1, wherein the memory protection policy is stored in the non-volatile memory.

7. A non-transitory computer readable storage medium encoded with instructions executable by a processor, the non-transitory computer-readable storage medium comprising:
instructions to receive a request to execute a write command to a non-volatile memory;
instructions to determine a usage level of the non-volatile memory;
instructions to determine a category of a variable associated with the write command;
instructions to compare the usage level of the non-volatile memory and the category of the variable associated with the write command to a memory protection policy; and
instructions to execute the write command to the non-volatile memory based on the instructions to compare.

8. The non-transitory computer readable storage medium of claim 7, wherein the request is received in a unified extensible firmware interface (UEFI) of a computing system.

9. The non-transitory computer readable storage medium of claim 8, wherein the set of memory protections comprises a plurality of different categories of allowable write commands, wherein each one of the plurality of different categories of allowable write commands is associated with a respective non-volatile memory usage threshold.

10. The non-transitory computer readable storage medium of claim 9, wherein the plurality of different categories comprises digitally signed variables, security-critical variables that are not digitally signed, any remaining known variables, and unknown variables.

11. The non-transitory computer readable storage medium of claim 10, wherein the plurality of different categories is tiered based on a remaining available non-volatile memory space.

12. The non-transitory computer readable storage medium of claim 8, wherein the memory protection policy is implemented when a non-volatile memory usage exceeds a threshold.

13. A non-transitory computer readable storage medium encoded with instructions executable by a processor, the non-transitory computer-readable storage medium comprising:
instructions to receive an identification of a category of a unified extensible firmware interface (UEFI) variable;
instructions to associate the category of the UEFI variable with a tag of the UEFI variable;
instructions to associate a non-volatile memory usage level with the category;
instructions to repeat the instructions to receive, the instructions to associate the category, and the instructions to associate the non-volatile memory usage level for a plurality of different categories of UEFI variables;
instructions to store the plurality of different categories of UEFI variables in a memory protection policy in a serial performance interface (SPI) chip; and
instructions to execute a UEFI SetVariable function of the UEFI based on the set of memory protections.

14. The non-transitory computer readable storage medium of claim 13, wherein the instructions to receive, the instructions to associate the category, and the instructions to associate the non-volatile memory usage level are defined via a UEFI user interface.

15. The non-transitory computer readable storage medium of claim 13, wherein the tag of the UEFI variable comprises a globally unique identifier.
